(19) United States
(12) Patent Application Publication
(10) Pub. No.: US 2013/0326855 A1
(43) Pub. Date: Dec. 12, 2013

(54) System and Method for Positioning and Fixing Objects Relative to Each Other

(71) Applicant: CERN - European Organization for Nuclear Research, Geneva (CH)

(72) Inventor: Albert Ijspeert, Geneva (CH)

(73) Assignee: CERN - European Organization for Nuclear Research, Geneva (CH)

(21) Appl. No.: 13/967,668

(22) Filed: Aug. 15, 2013

Related U.S. Application Data
(63) Continuation of application No. PCT/EP2011/000761, filed on Feb. 17, 2011.

(51) Int. Cl. H02K 15/00

(52) U.S. Cl. CPC H02K 15/00
USPC 29/428; 29/281.5

(57) ABSTRACT

A system and method are described for positioning and fixing a number of objects relative to each other. Each lamella in a stack have a number of pockets for receiving the objects. At least some of the pockets are dimensioned so as to loosely receive the corresponding object without applying a substantive clamping force. The relative position of at least some of the pockets in one subset of lamellae as oriented in the stack deviate from the relative positions of the same pockets in another subset of the lamellae such that the clamping force is generated between the objects and the stack of lamellae when the objects are simultaneously inserted in the corresponding pockets all lamellae of the stack.

This application is a continuation of co-pending Patent Cooperation Treaty Patent Application PCT/EP2011/000761, filed Feb. 17, 2011 and published as WO 2012110056 A1 on Aug. 23, 2012, which is incorporated herein by reference.

### TECHNICAL FIELD

The present invention is in the field of mechanical and electrical engineering and finds use in situations where a number of objects need to be positioned and fixed relative to each other. A particularly useful application of the system and the method is an electric motor, where permanent magnets and a rotor shaft need to be positioned and fixed relative to each other.

### BACKGROUND ART

A typical application where a system for positioning and fixing a number of objects relative to each other is required are permanent magnet rotors of electric motors. At present the permanent magnets in the rotors of Internal Permanent Magnet motors (IPM motors) are generally fixed by gluing these in slots in the rotor. The disadvantage is the time consuming gluing and curing operation. Another disadvantage is that the magnets cannot be dismounted without damage and can therefore not be recuperated or exchanged. Therefore solutions have been sought to fix the magnets in a purely mechanical way. In FIG. 1 a longitudinal sectional illustration of a permanent magnet rotor 10 is shown, which has been taken from US 2010/0141074 A1. The rotor 10 comprises the rotor shaft 12 to which a rotor packet 14 is fastened.

The rotor packet 14 is a sheet packet which is composed of a multiplicity of sheet lamellae 16, which may also be referred to as “sheet laminations”, “laminations”, “plates”, or “washers”. All of these types of objects shall be referred to as “lamellae” in the following.

Permanent magnets 18 are received in corresponding reception pockets 20 in each of the lamellae 16. In order to prevent the permanent magnet 18 to fall out of the channel formed by the aligned reception pockets 20 in the lamellae 16, projections 22 in the two lamellae forming the respective end faces of the rotor packet 14 are plastically deformed such as to decrease the size of the respective pocket 20 after insertion of the permanent magnets 18. Accordingly, this system for fixing the magnets 18 relies on a plastic deformation of the outermost lamellae 16. The fixation of the rotor packet 14 on the rotor shaft 12 is not described in this prior art document.

U.S. Pat. No. 4,486,679 also discloses a permanent magnet rotor comprising a stack of lamellae 16, two overlapping ones of which being shown in FIGS. 2 and 3 taken from said prior art document. Each of the lamellae 16 has a number of pockets 20 for receiving a corresponding one of the permanent magnets 18. The pockets 20 for receiving the magnets 18 are not symmetric relative to the quadrature axes 23. Accordingly, if the lamellae 16 are stacked in different orientations, the end portions of overlying pockets 20 do not match. Instead, the ends of adjacent pockets 20 in consecutive lamellae slightly overlap, thereby forming a central aperture 24 extending axially through the lamellae stack, as is shown in FIG. 2.

As is further shown in FIG. 2, thin circumferential bridges 26 are located at the rotor periphery where the ends of two adjacent pockets 20 meet. For clamping the magnets 18 in the pockets 20, the bridges 26 are pressed inwardly such as to be plastically deformed, thereby creating depressions 28 as shown in FIG. 3. Also, due to a specific collapsible shape of ligaments 29a, 29d between the ends of adjacent pockets 20, the ligaments 29a, 29d collapse in a way to increase the central aperture 24 and to form a central tunnel 30. If necessary, a pin (not shown) may be inserted into the central tunnel 30 such as to lock the collapsed ligaments 29a, 29d in place and hence maintain the clamping force on the permanent magnets 18.

Accordingly, in case of U.S. Pat. No. 4,486,679 too, the magnets are fixed by plastic deformation of the lamellae. However, in this case, the plastic deformation does not simply close the channel formed by the reception pockets, but exerts a clamping force on the magnets 18. Also, in this prior art the fixation of the rotor packet on the rotor shaft is not described either.

A permanent magnet rotor with surface magnets held by a stack of lamella is known from WO 2007/074036 A1.

### SUMMARY

A general problem underlying the invention is to provide a system and method for positioning and fixing a number of objects relative to each other which allows for an easy and quick assembly.

Also, while the systems for positioning and fixing employed in the above prior art documents US 2010/0141074 A1 and U.S. Pat. No. 4,486,679 allow to position and fix the magnets at the periphery of the rotor packet, none of the fixation systems allows to also fix the rotor axis. In particular, it is quite obvious that the clamping achieved by plastic deformation as employed in U.S. Pat. No. 4,486,679 can be used in the periphery of the lamellae, but not at a central portion thereof. It is thus a further object underlying the invention to provide a system and method for positioning and fixing objects providing for an improved flexibility with regard to the location of the objects to be fixed.

These problems are solved by a system according to claim 1 and a method according to claim 14. Preferable embodiments are defined in the dependent claims.

The system of the invention comprises a stack of lamellae, where each lamella has a number of pockets for receiving the objects. At least some of the pockets are dimensioned such as to loosely receive the corresponding objects without applying a substantive clamping force to it. However, the relative positions of at least some of the pockets in one subset of lamellae as oriented in the stack deviate from the relative positions of the same pockets in another subset of the lamellae, such that a clamping force is generated between the objects and the stack of lamellae when plural objects are inserted in the corresponding pockets of all lamellae of the stack of lamellae.

According to the invention, the clamping force is therefore not or at least not exclusively caused by a tight fit between the object and the corresponding pocket as such. Instead, some or all of the pockets are dimensioned such as to loosely receive the corresponding object by itself. A clamping force only occurs due to the fact that the positions of the same pockets in different lamellae do not entirely match. Instead, the relative positions of at least some of the pockets in one subset of lamellae—as oriented in the stack—deviate from the relative positions of the same pockets in another subset of lamellae, thereby effectively narrowing the channel formed by the respective pocket in each lamella of stack of lamellae. In this regard, the “same pocket in different lamellae” are pockets of different lamellae that shall receive the same object. Note that the term “as oriented in the stack” accounts for an important special case described below, in which the lamellae as such are all of the same shape but the clamping is achieved by stacking them in different orientations, as will be described below.

Note that unlike a clamping that is based on a plastic deformation, the location of the objects are not limited to the periphery of the lamellae. Instead, the pockets and hence the objects can be positioned wherever desired, adding to the positional flexibility of the system.

Also, since the clamping is not or at least not exclusively achieved by a tight fit between the individual pocket and the object, inserting the first ones of the objects through the pockets is very easy. A clamping force is only built up when the final ones or even the very final one of the objects is inserted, for example by press fitting. Then, the clamping force is built up by the sliding movement of the final object(s) through the pockets expanding the channel(s) of this (these) object(s) and pushing the lamellae such as to narrow the other channels, which in practice proves to be a very simple and elegant way to build up the clamping force, and allows for a very easy assembly.

It is noted that a conceptually related system has been proposed earlier by the present inventor in EP 1 094 266 A1, although this system does not relate to positioning and fixing a number of objects relative to each other. Instead, this prior art system was devised for positioning one or more inner bodies with regard to an outer body, where the outer body and the object or objects to be positioned have incompatible shapes, e.g. a circular outer body and a square object. This system also employs a stack of lamellae with plural pockets, but the relative positions of all pockets are the same for all lamellae whereas the outer rim of each lamella has been slightly offset. Accordingly, positioning and fixation can only be achieved if the objects and the lamellae are clamped inside an additional outer body, unlike the present invention. Also, it should be mentioned that this earlier system was devised with an eye on positioning rather than on fixation and that the assembly was preferably done by shrink-fitting the outer body around the stack of lamellae with the objects already in place whereas assembly by pressfitting the objects would be very difficult in this configuration.

As mentioned above, in a preferred embodiment the objects comprise magnets and/or a rotor shaft of an electric motor.

In a preferred embodiment, the “deviation in relative positions” of at least some of the pockets of at least some of the lamellae referred to above is such that a clamping force exerted by one of the lamellae on one object has a component opposite to the clamping force exerted by the same lamella to another object. If a single lamella, as part of the stack and with objects inserted through its pockets, generates opposing clamping forces, no further holding or fixation structure is necessary in addition to the lamellae and the objects themselves. This is different from the afore-mentioned EP 1 094 266 A1, where each lamella can only generate clamping forces on all objects in the same direction and therefore inevitably needs a further structure to rest on or against, namely the outer body employed in this prior art. In contrast, the present invention allows to position and fix a number of objects relative to each other with a stack of lamellae only, without need for any further structure such as an outer body surrounding the stack of lamellae.

In one embodiment, the “deviation in relative position” of two pockets in a first subset of lamellae as compared to the relative positions thereof in a second subset of lamellae is an increase in distance between the two pockets. Herein, in the first subset of lamellae, a clamping force is exerted on the objects received in said two pockets by respective pocket edge portions facing each other. Conversely, in said second subset of lamellae, a clamping force is exerted on the same objects received in the two pockets by respective pocket edge portions facing away from each other. Note in this regard that in the present disclosure, a “subset” of lamellae or pockets can refer to a single lamella/pocket only. Varying the distances between pairs of pockets between different lamellae is hence one way of generating opposing clamping forces on different objects within one and the same lamella.

In a preferred embodiment, each of the pockets is loosely fitting a corresponding one of the objects. Herein, “loosely fitting” means that no substantial clamping force is generated when the object is inserted in the pocket of a single lamella (i.e. not as part of the lamellae stack), but that the shape and size of the pocket is similar to the cross-section of the object. In particular, the area of the pocket may exceed the cross-sectional area of the corresponding object by an amount sufficient to take care of the tolerances of the objects, the tolerances of the pockets of the lamellae and the desired assembly play, such as by 1% to 50%, preferably by 5% to 30%.

In a preferred embodiment, the relative positions of a first subset of pockets of all lamellae as oriented in the stack are identical, and only the relative positions of the remaining pockets with respect to at least some of the pockets of the first subset of pockets deviate from each other for different lamellae as oriented in the stack. This means that upon assembly, first all objects related to the first subset of pockets can be easily inserted without any clamping, because the relative positions of the first subset of pockets are identical for all lamellae. A clamping force only occurs when the remaining object or objects are inserted to the remaining pockets, such as by press fitting. Then, the clamping force is built up due to the sliding motion of the remaining objects, possibly of a single remaining object through the pockets by expanding the channel(s) formed by the remaining pocket(s) and in this way narrowing the channels formed by the first subset of pockets. This allows for a very easy and efficient assembly.

In a preferred embodiment, the first subset of pockets are arranged in a rotationally symmetrical or mirror-symmetrical pattern on the lamellae. This means that the same relative positions of the first subset of pockets are maintained when the lamellae are positioned in different rotational orientations (in case of rotational symmetry), or when the lamella is positioned upside down (in case of mirror-symmetry). The deviation in relative positions of the remaining pockets with respect to at least some of the pockets of the first subset of pockets for different lamellae can then be achieved by orienting different lamellae in the stack in different rotational positions or upside down.

This reduces the manufacturing and storage costs for the lamellae. This preferred embodiment also further explains the attribute “as oriented in the stack” recited above. Namely, by positioning identical lamellae at different rotational positions or upside down in the stack of lamellae, different relative positions of pockets in different lamellae receiving the same objects can be obtained although the lamellae are per se of identical shape. This will be further illustrated by specific examples below.

In a particularly preferred embodiment, the first subset of pockets comprises all but one pocket of each lamella, and the single remaining pocket is offset from the rotational symmetry axis. This is a very simple and efficient way to fix N objects (e.g. permanent magnets) arranged in a rotationally symmetric pattern around a central object (e.g. a rotor shaft) using only a single type of lamella arranged in different rotational orientations in the stack. Herein, N is an integer number that is generally only limited by practical considerations.

Again, this embodiment has the remarkable advantage that all of the N objects can be easily inserted through the pockets of the lamellae of the stack without any considerable clamping force, while the clamping forces are only built up by the sliding movement of the last, central object when pressed through the channel formed by slightly off-centered pockets of the lamellae. The buildup of clamping force can be further facilitated if the remaining object, i.e. the object that is inserted last, has a tapered shape or at least a leading tapered portion.

In one embodiment, the pockets are formed by through holes in the lamellae. However, the pockets are not limited to this. Instead, the pockets may also be formed by recesses that are at least partially encompassing the object in a way allowing for a clamping force between the object and the lamella to occur. This will be further illustrated below with reference to a specific embodiment.

In an alternative embodiment, each of the lamellae consists of two pieces, an outer piece and an inner piece. The two pieces may e.g. be manufactured by removing material bridges that linked the inner and outer section of a blank one-piece lamella. In this embodiment, at least one pocket is formed in the inner piece and at least one further pocket is defined by an outer edge portion of the inner piece and an opposing inner edge portion of the outer piece. This embodiment too is based on the general concept of different relative positions of pockets in different lamellae of the stack, and hence also allows to generate opposing clamping forces within a single lamella, thus making additional structures like an outer body obsolete. However, due to the split structure of the lamellae, in this embodiment the pocket defined by the outer edge portion of the inner piece and the opposing inner edge portion of the outer piece effectively has a variable size.

In a preferred embodiment, the outer pieces in all of the lamellae are identical, and the relative positions of at least one of the edges of the inner piece and at least one pocket in said inner piece of one subset of lamellas deviate from the corresponding relative positions in another subset of lamellae.

### BRIEF DESCRIPTION OF THE DRAWINGS

FIG. 1 shows a sectional view of a rotor packet according to prior art.

FIGS. 2 and 3 are plan views onto portions of lamellae as used in a rotor packet according to prior art.

FIG. 4a illustrates a system for positioning and fixing four permanent magnets and a rotor shaft according to an embodiment of the invention, illustrating two lamellae of a corresponding stack of lamellae.

FIG. 4b shows the position of the upper lamella of the lamellae stack of FIG. 4a, with respect to the magnets and the rotor shaft.

FIG. 4c shows the position of the lower lamella of the lamellae stack of FIG. 4a, with respect to the magnets and the rotor shaft.

FIG. 5a and b shows a longitudinal sectional view and a perspective view of a rotor pack employing the positioning and fixing system of FIG. 4.

FIGS. 6a and 6b show the position of two consecutive lamellae of the same stack of lamellae with respect to the magnets and the rotor shaft in an alternative embodiment of the invention.

FIGS. 7a and 7b show snap-shots illustrating the assembly of the lamellae of FIGS. 6a and 6b, the magnets and the rotor shaft.

FIG. 8a is a plan view onto a lamella stack according to another embodiment of the invention allowing the fixation of a rotor shaft and surface magnets.

FIG. 8b illustrates the mounting of the lamella stack of FIG. 8a.

FIG. 9 is a plan view showing two split lamellae stacked on top of each other, each split lamella comprising an inner piece and an outer piece.

FIGS. 10a-10c show alternative embodiments of a system of the invention that are particularly useful for holding objects for machining.

FIG. 11a-11c show systems with the same lamellae as in FIGS. 10a to 10c, but where the objects held have round cross sections rather than square cross sections.

FIG. 12 shows a further embodiment of a system of the invention in which the deviation of relative position of pockets in different subsets of lamella amounts to a different relative orientation of said pockets.

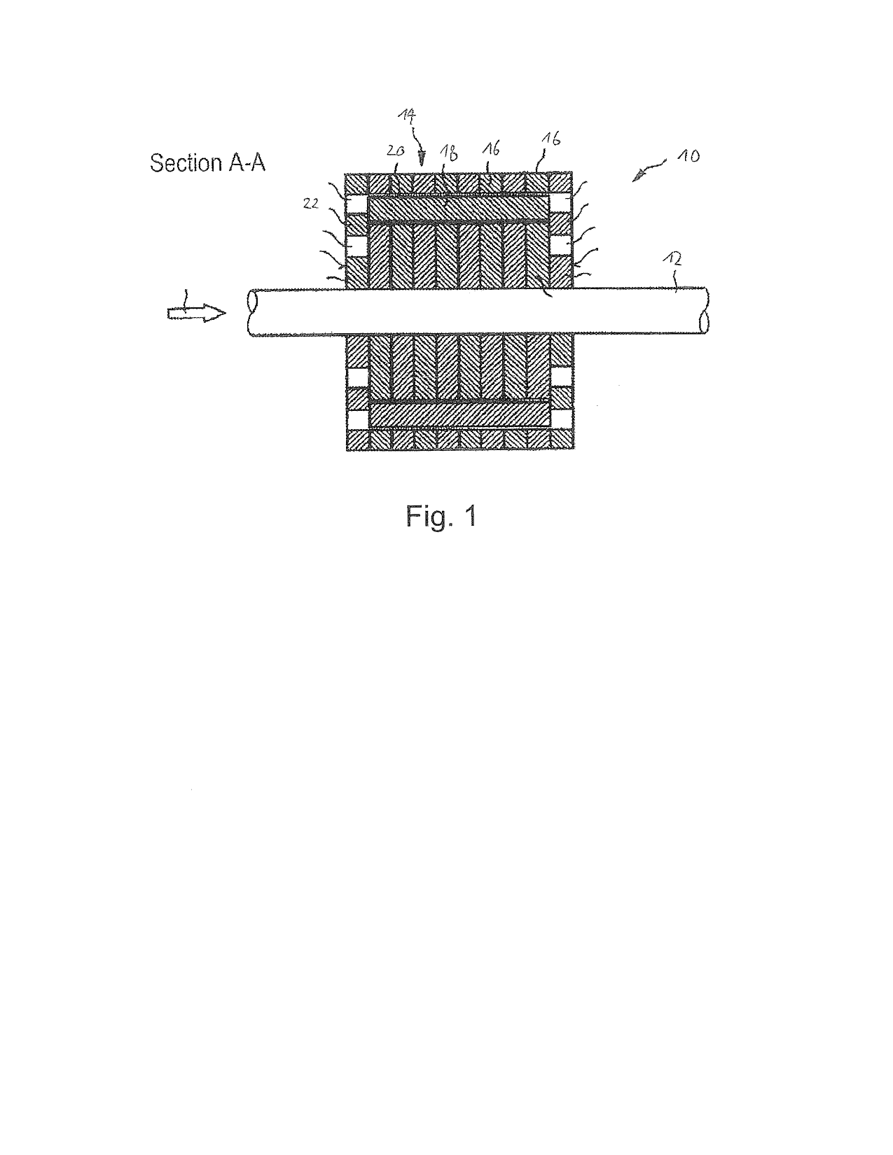

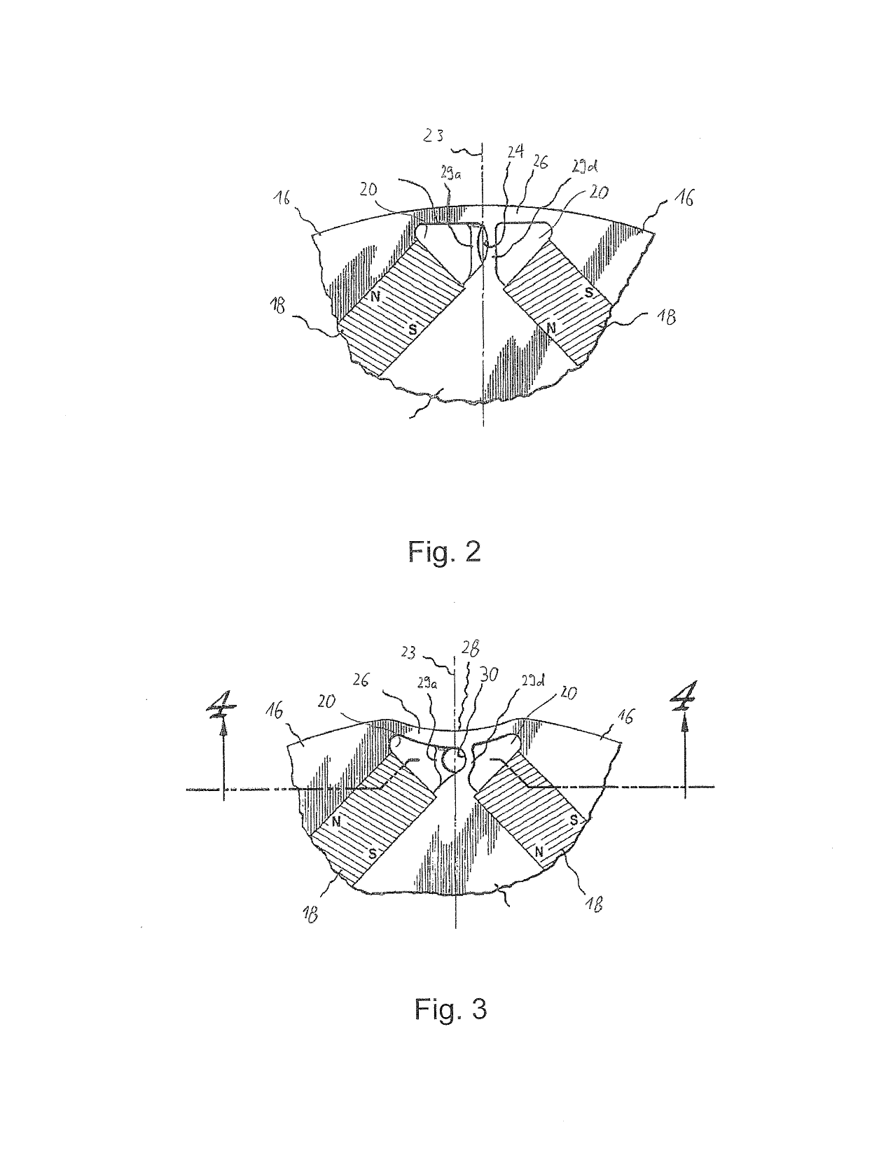

### DETAILED DESCRIPTION

For the purposes of promoting an understanding of the principle of the invention, reference will now be made to the preferred embodiments illustrated in the drawings, and specific language will be used to describe the same. It will nevertheless be understood that no limitation of the scope of the invention is thereby intended, such alterations and further modifications in the illustrated system and method, and such further applications of the principles of the invention as illustrated therein being contemplated as would normally occur now or in the future to one skilled in the art to which the invention relates.

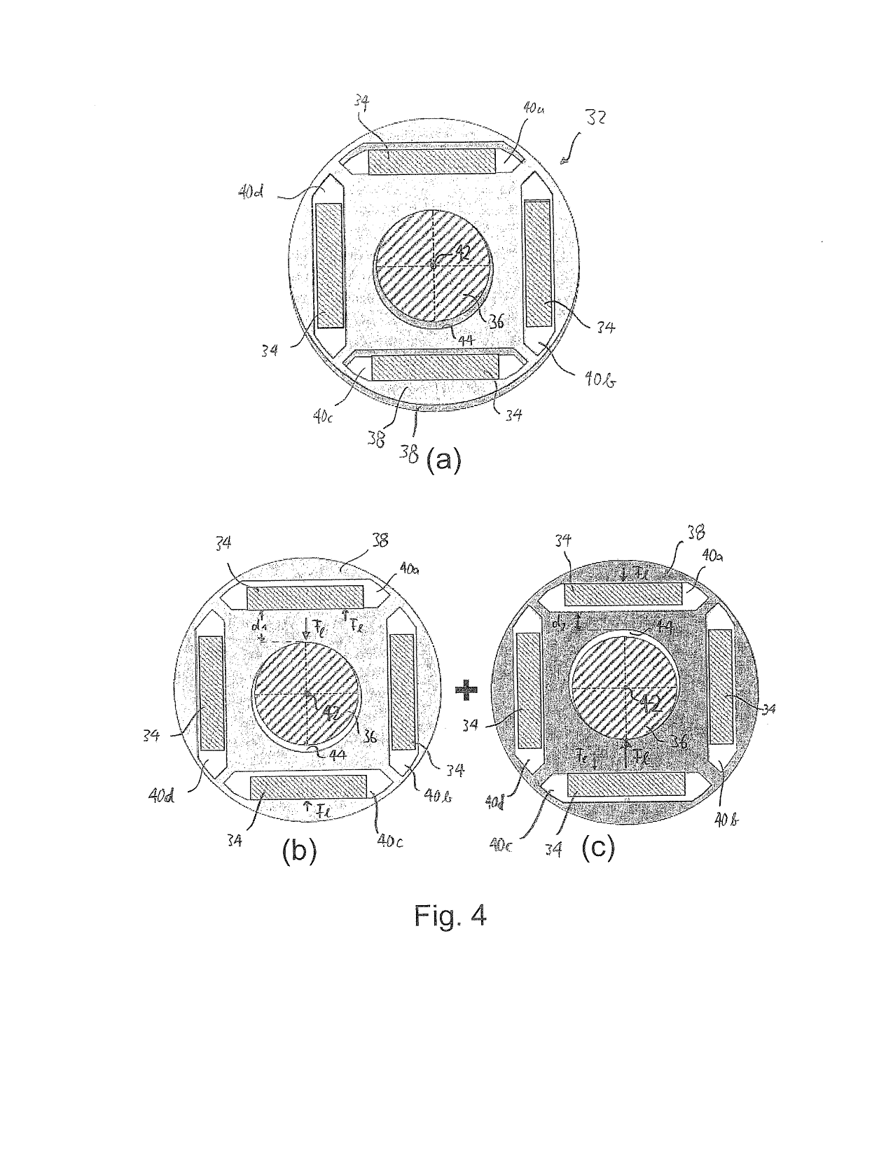

In FIG. 4a, a system 32 for positioning and fixing four permanent magnets 34 and a rotor shaft 36 relative to each other is shown in an end view. The actual system 32 comprises a stack of multiple lamellae 38, of which however only two are shown in FIG. 4a. Herein, the term “lamella” shall be interpreted in its broadest possible sense and should comprise objects also usually referred to as “plate”, “lamination” or “washer”.

To further illustrate the function of the positioning and fixing system 32, in FIG. 4b only the upper lamella 38 of FIG. 4a is shown as positioned with respect to the magnets 34 and rotary shaft 36. Likewise, in FIG. 4c, only the lower lamella 38 of FIG. 4a is shown as positioned relative to the magnet 34 and rotary shaft 36.

As can be seen from FIGS. 4a to 4c, each lamella 38 has four pockets 40a to 40d for receiving the magnets 34, that are arranged in a rotationally symmetric pattern about a symmetry axis 42, that is perpendicular to the paper plane in FIGS. 4a to 4c. In addition, each lamella 38 comprises a further pocket 44 for receiving a central object, in this example the rotary shaft 36. The center of this further pocket 44 is slightly offset from the symmetry axis 42. Accordingly, when the lamellae 38 are stacked in different orientations, the pockets 40a to 40d and 44 of different lamellae cannot all be flush with each other at the same time. This can be directly seen in FIG. 4a, where the upper lamella and the lower lamella are rotated with respect to each other by 180°.

With particular reference to FIGS. 4a to 4c, this has the effect that the relative position of the central pocket 44 with respect to for example pocket 40a of the upper lamella 38 (see FIG. 4b) is different from the relative position of the central pocket 44 with respect to pocket 40a in the second lamella 38 (see FIG. 4c). In particular, the distance d₁ between the central pocket 44 and pocket 40a of the upper lamella 38 (see FIG. 4b) is larger than the corresponding distance d₂ in the lower lamella 38 (see FIG. 4c) as oriented in the stack. This deviation in relative position of the pockets leads to clamping forces to occur between the lamellae 38 and the objects, i.e. the magnets 34 and the rotary shaft 36. In FIGS. 4b and 4c, the clamping forces F₁ of the lamellae 38 acting on the corresponding object (magnet 34 or rotary shaft 36) are illustrated by force arrows.

Note that for both lamellae 38, the clamping force F₁ exerted by the respective lamella 38 on the magnets 34 in pockets 40a and 40c is opposite to the clamping force exerted by the same lamella 38 on the rotary shaft 36. In fact, in this arrangement there is no net external force, i.e. no additional structure like an outer body surrounding the lamellae 38 is needed for fixing the magnets 34 and rotary shaft 36 relative to each other.

Note further that the two lamellae 38 shown in FIG. 4 only fix the magnets 34 in pockets 40a and 40c relative to the rotary shaft 36, but do not apply any clamping to the magnets 34 disposed in pockets 40b and 40d. This can, however, be most easily achieved by employing another pair of lamellae 38 (not shown) each rotated by 90° with respect to the two lamellae 38 shown in FIG. 4. Also, in a practical implementation of the system 32, generally a multiple of groups of four lamellae with the four respective orientations would be employed, which is however not shown in FIG. 4 for simplicity.

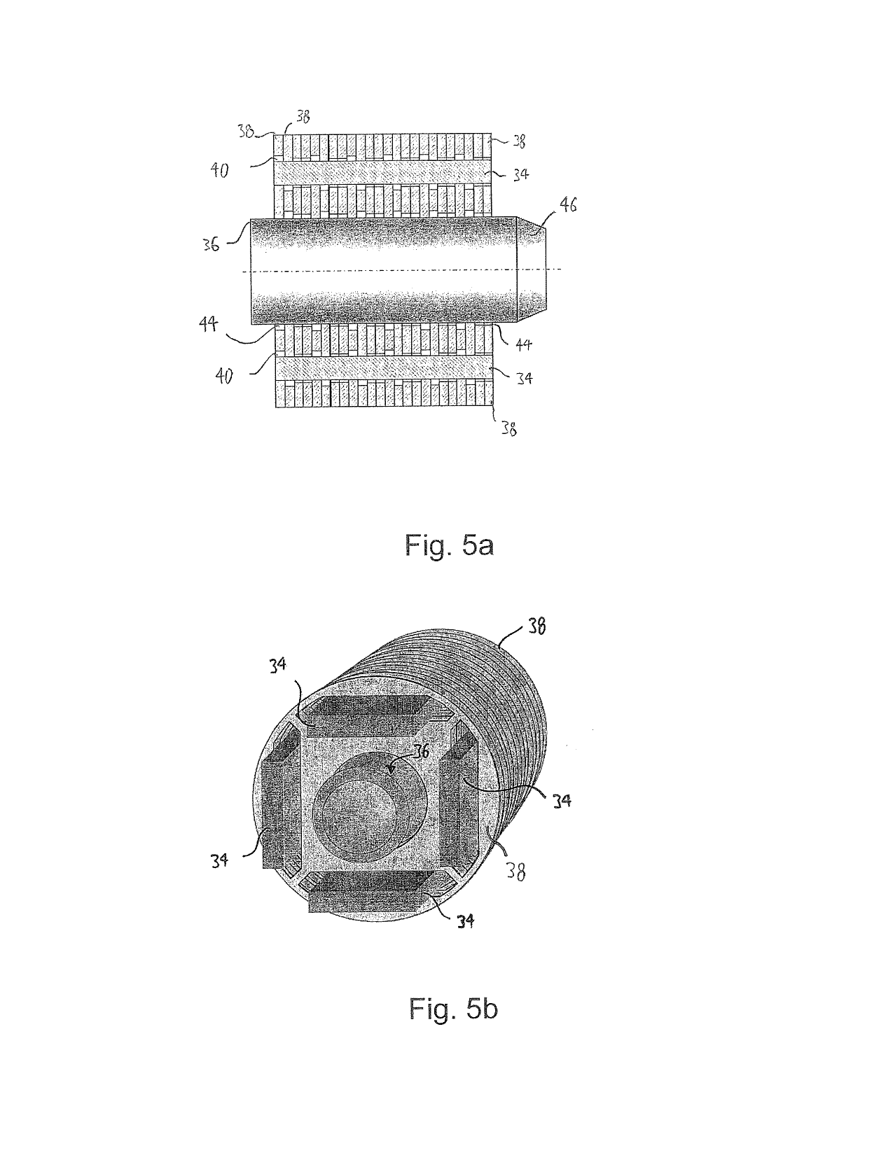

FIG. 5a shows a longitudinal sectional view and FIG. 5b a perspective view of a rotor pack employing the positioning and fixing system 32 of FIG. 4. As can be seen in FIG. 5a, the stack of lamellae 38 comprises 24 lamellae 38, namely six groups comprised of four lamellae 38 each, which are oriented in the four different orientations. FIG. 5a illustrates how the difference in relative positions of pairs of pockets in different lamellae lead to a clamping force between the magnets 34 and the rotor shafts 36 when they are simultaneously located in the channels formed by the respective pockets. As is also seen in FIGS. 5a and 5b, the rotary shaft 36 has a tapered portion 46 for easier insertion into the central pocket 44.

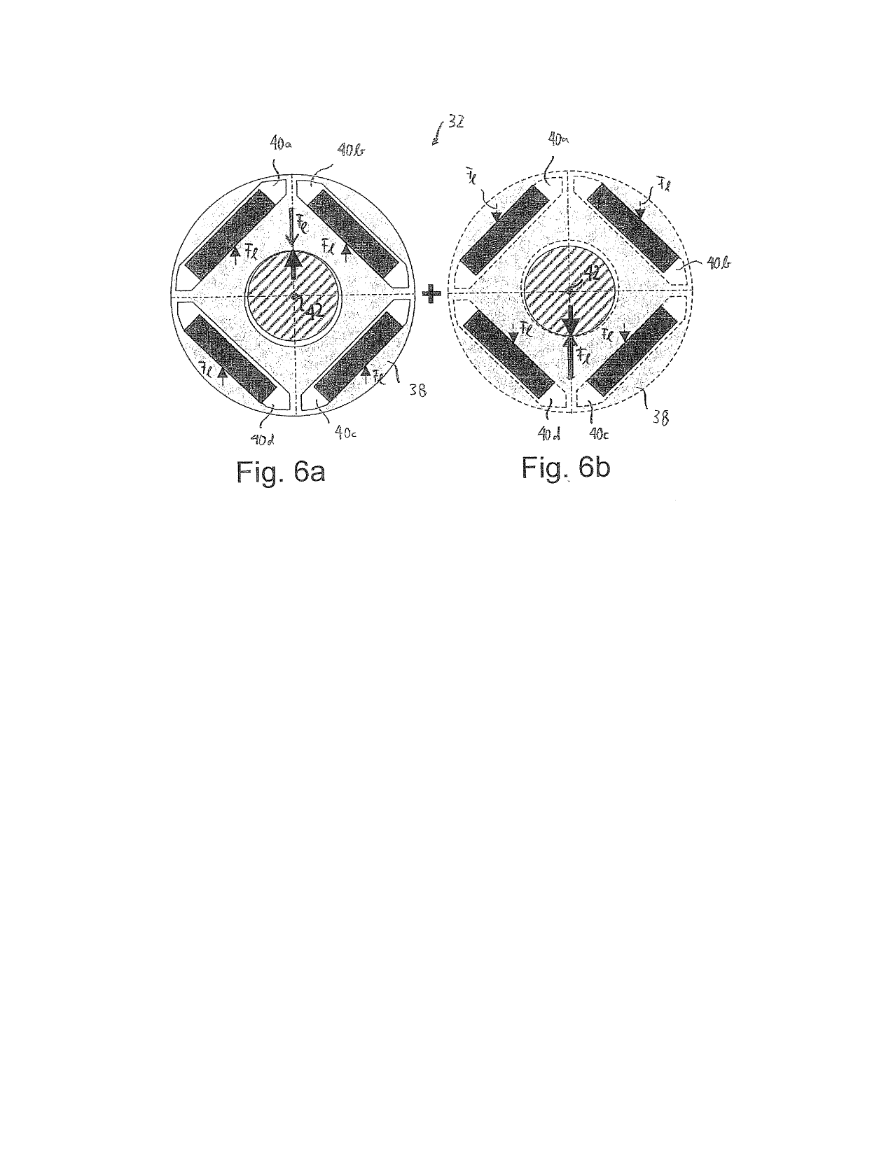

FIGS. 6a and 6b show views of consecutive lamellae 38 similar to those of FIGS. 4b and 4c in a slightly modified version of the system 32. The main difference between the lamellae 38 of the embodiment of FIG. 6 as compared to the embodiment of FIG. 4 is that the offset of the central pocket 44 does not directly point to one of the magnet pockets (e.g. pocket 40a in FIG. 4b), but along the angle bisector between pocket 40a and 40b. This means that each lamella 38 will exert clamping forces on all four magnets 34 simultaneously, as is indicated by the force arrows in FIGS. 6a and 6b.

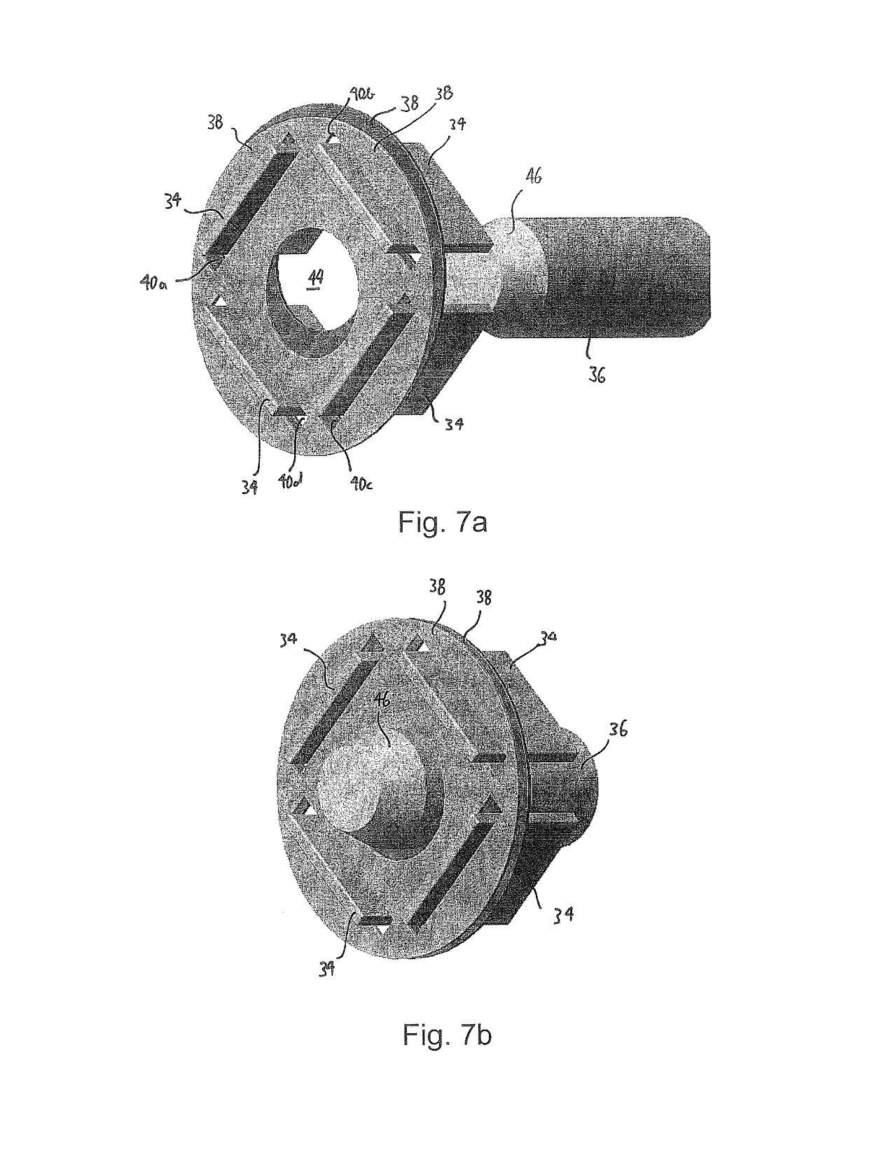

With reference to FIGS. 7a and 7b, the assembly of the system 32 of FIG. 6 is illustrated.

FIG. 7a shows a snap shot of the system 32 upon assembly. At this instance, the permanent magnets 34 are already inserted in the corresponding pockets 40a to 40d. Since the pockets 40a to 40d are arranged in a rotationally symmetric pattern, even in the different rotational orientations of the lamellae 38, the relative positions of the pockets 40a to 40d are identical in all lamellae. This means that the magnets 34 can be easily inserted without any clamping yet occurring and hence without any special tool.

The clamping forces are only generated upon insertion of the rotary shaft 36 through the central (but slightly off-centered) pockets 44, i.e. upon the transition from FIG. 7a to FIG. 7b. Herein, the clamping forces build upon the sliding motion of the rotary shaft 36 through the pockets 44 of the stack lamellae 38, of which in FIGS. 7a and 7b again only two are shown for illustrative purposes. The insertion may be achieved in a press-fit step, which is facilitated by a tapered conical end 46 of the rotary shaft 36.

Accordingly, the embodiments of FIGS. 4 and 6 allow for a very easy and quick assembly that can be particularly advantageously employed in the manufacture of permanent magnet rotor packets for electric motors and allows for a high degree of automation. However, the positioning and fixation system and method of the invention is not limited to this application, as it allows to generally position and fix arbitrary objects with respect to each other.

Also, the concept of a lamella with a subset of pockets arranged in a rotationally symmetric pattern is clearly not limited to a fourfold rotational symmetry, but can be generalized in a straight forward manner to N-fold symmetries, where N is an integer of two or more and is basically only limited by the number of lamellae 38 that will have to be employed.

It is further to be understood that the system can also be applied for fixing objects with respect to each other that are not arranged in any symmetric pattern. The clamping can in fact be obtained for arbitrary patterns of objects, as long as the relative positions of at least some of the pockets in one subset of lamellae as oriented in the stack deviate from the relative positions of the same pockets in another subset of lamellae.

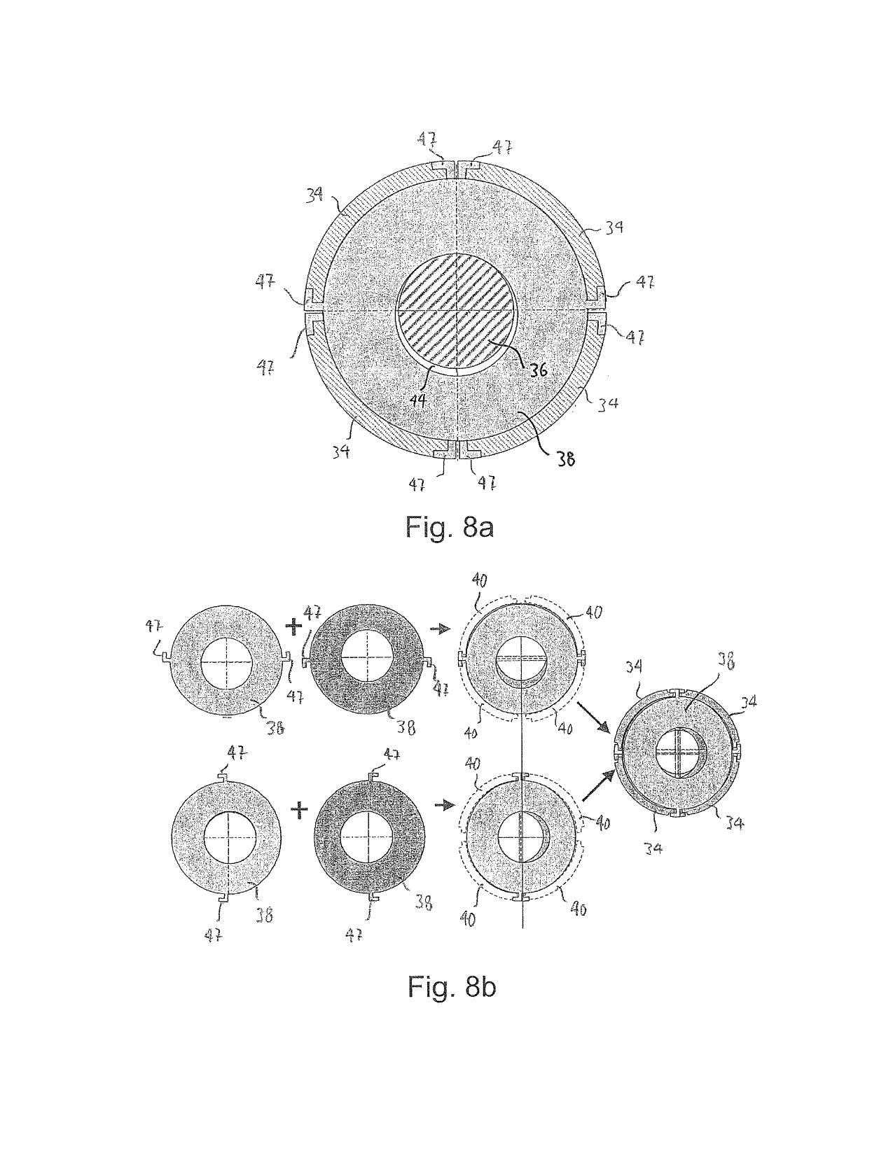

While the pockets 40a to 40d in FIGS. 4 and 6 are formed by holes in the lamellae 38, the invention is not limited to this. Instead, the pockets may be any type of recess or structure that at least partially encompasses the object in a way for allowing the clamping force between the object and the lamella to occur. An example of such “non-closed pockets” is shown in FIG. 8a. FIG. 8 shows a yet further embodiment of a system 32 for fixing magnets 34 and the rotor shaft 36 with respect to each other. In this embodiment, the magnets 34 are surface magnets held in circumferential pockets 40 formed by the lamellae 38. The structure of the lamellae and pockets 40 is illustrated by FIG. 8b, where the assembly is illustrated with reference to four lamellae 38 which are stacked in different orientations. Each lamellae 38 has two hook-shaped arms 47, each for receiving and partially encompassing one circumferential end of a surface magnet 34. Each of the hook-like arms 47 hence defines a pocket for loosely receiving a corresponding object without applying a substantive clamping force to the object yet. The corresponding pockets 40 are indicated by dash lines in FIG. 8b. In addition, each lamella 38 comprises a pocket 44 for receiving a central object, in this particular example a rotary shaft 36. Note that again, the pocket 44 for receiving the rotary shaft is slightly off-centered.

The lamellae 38 are stacked in the four different orientations indicated in FIG. 8b, and the surface magnets 34 can be inserted to the pockets 40 formed between pairs of arms 47 facing each other, where each arm 47 of these pairs of arms are located on different lamellae 38. Note that this assembly of the surface magnets is possible without substantial clamping forces yet occurring. However, due to the slightly eccentric position of the pocket 44, the pockets 44 of different lamellae are not aligned with each other. When the rotary shaft 36 is pressed through the channel formed by the respective pockets 44 of the lamellae 38, the lamellae 38 are forced in the position shown in FIG. 8a where the surface magnets 34 and the rotary shaft 36 are clamped.

While the pockets 40 formed by the hook-like arms 47 at first sight look very different from the pockets 40 as shown in FIGS. 4 to 7, in each case the pockets 40 have the following common general features:

each of the pockets is dimensioned such as to loosely receive the corresponding object by itself, i.e. without applying a substantive clamping force to the object yet,

the relative positions of the pockets 40 (as defined by the position of the hook-like arm 47 in the embodiment of FIG. 8 or by the location of the magnet receiving holes in the embodiments of FIGS. 4 to 7) on the one hand and the pockets 44 on the other hand deviate from each other for different lamellae as oriented in the stack of lamellae, and

this deviation is chosen such that a clamping force is generated between the objects and the stack of lamellae when the objects are simultaneously located in the corresponding pockets of all lamellae of the stack of lamellae.

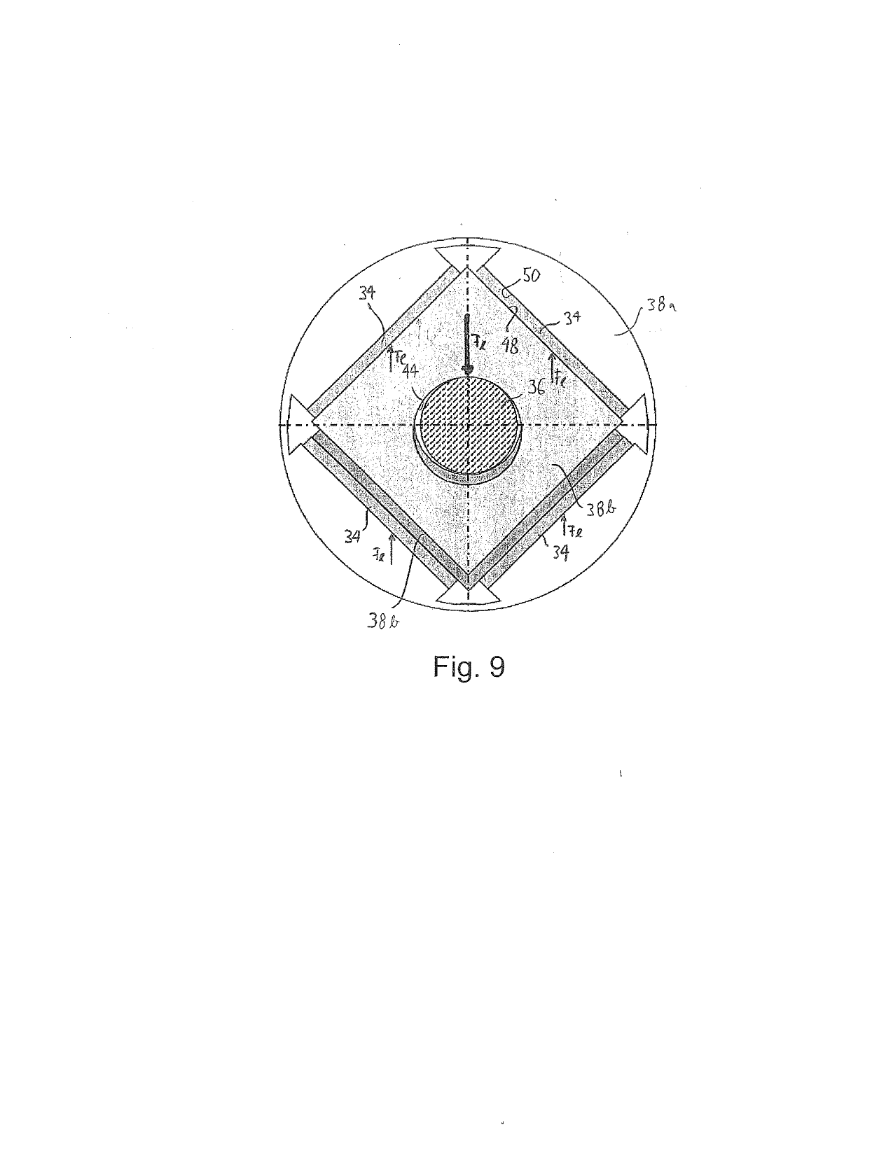

A further embodiment is shown in FIG. 9. In the embodiment of FIG. 9, the bridges of material in FIG. 6 that linked the inner part of the lamella to the outer part of the lamella blank have been suppressed and each lamella 38 hence consists of two pieces, namely an outer piece 38a and an inner piece 38b. In this embodiment, all the outer pieces 38a are identical and rotationally symmetric. The inner pieces 38b are identical, too, but not rotationally symmetric. Instead, each inner piece 38b has a square shape with a pocket 44 that is slightly offset from the center of the square inner piece 38b. In this embodiment, the pocket 44 is again used for receiving the rotary shaft 36. In this embodiment, the pockets for receiving the magnets 34 are defined by an outer edge portion 48 of the inner piece 38b and an opposing inner edge portion 50 of the outer piece 38a. Consequently, depending on the orientation of the inner piece 38b in the stack, different pairs of magnets 34 will be clamped simultaneously from both sides between the outer edge portion 48 of the inner piece 38b and the inner edge portion 50 of the outer piece 38a. Accordingly, in this embodiment, the pockets for the magnets may be regarded as variable size pockets.

Comparing FIG. 9 with FIG. 6a, it is seen that in FIG. 6a the upward force F₁ is transmitted through the square central part of the lamella 38 to the lower sides of the upper magnets 34, while it is transferred to the lower sides of the lower magnets 34 by the outer portion of the lamella via the material bridges between the square central and outer parts. In the embodiment of FIG. 9, there are no bridges between the outer and inner pieces 38a, 38b anymore. The upward force is transferred by the square inner piece 38b to the lower sides of the upper magnets 34 and further transferred via the upper magnets to the outer piece 38a, which in turn exerts the clamping force to the lower sides of the lower magnets 34.

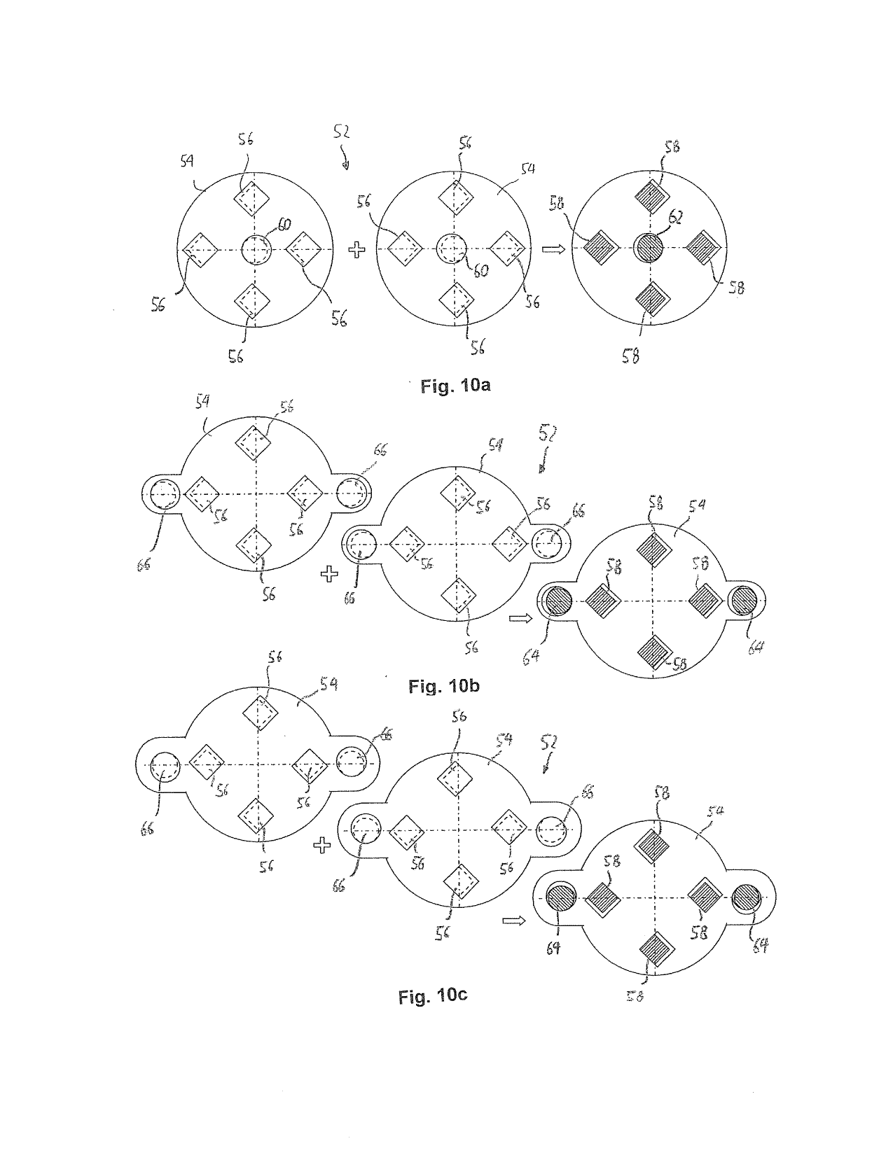

Further exemplary systems for positioning and fixing a number of objects relative to each other are shown in FIGS. 10a-c and 11a-c. FIG. 10a shows a system 52 comprising a stack of lamellae 54 of which only two are shown in FIG. 10a. Each lamella 54 has five pockets, namely four outer pockets 56 for receiving square diameter objects 58 and a central pocket 60 for receiving a central shaft or dowel 62. In the left half of the figure the two lamellae 54 with empty pockets 56, 60 are shown, and the position of the objects 58 and shaft 62 in the clamped state is indicated by the broken lines. Note that this embodiment is functionally very similar to the rotor pack of FIG. 6, except that in this embodiment the lamellae 54 are meant to be only placed in two opposite orientations, namely by rotating consecutive lamellae 54 by 180° or, equivalently, flipping each consecutive lamella 54 to be upside down, i.e. having alternating “up-down-configurations”.

In the example of FIG. 10a, the objects 58 could e. g. be bars that are to be mounted for successive machining under a CNC machine. The central object 62 could again be a central shaft or dowel that is press-fitted into central pockets 60. Since in a machining application the system is assembled and disassembled frequently, instead of press-fitting the central object 62, it would be also possible to have a central object 62 with an extendable cross section that could be easily inserted into central pocket 60 in a collapsed state and then expanded to an increased cross section state.

FIG. 10b shows a related example in which the central object has been replaced by two peripheral objects 64 in corresponding pockets 66. The function is the same as in FIG. 10a, but the peripheral objects or shafts 64 are kept outside the working area of the objects 58. Again, the peripheral objects or shafts 64 can have an extendable cross section.

The embodiment of FIG. 10c is again a variant of the embodiment of FIG. 10b, where the peripheral objects 66 do not exert lateral clamping forces but rotational clamping forces. In the leftmost lamella 54 of FIG. 10c, the peripheral objects 66 push the lamella 54 in a clockwise direction, while the second lamella 54 is pushed in a counterclockwise direction.

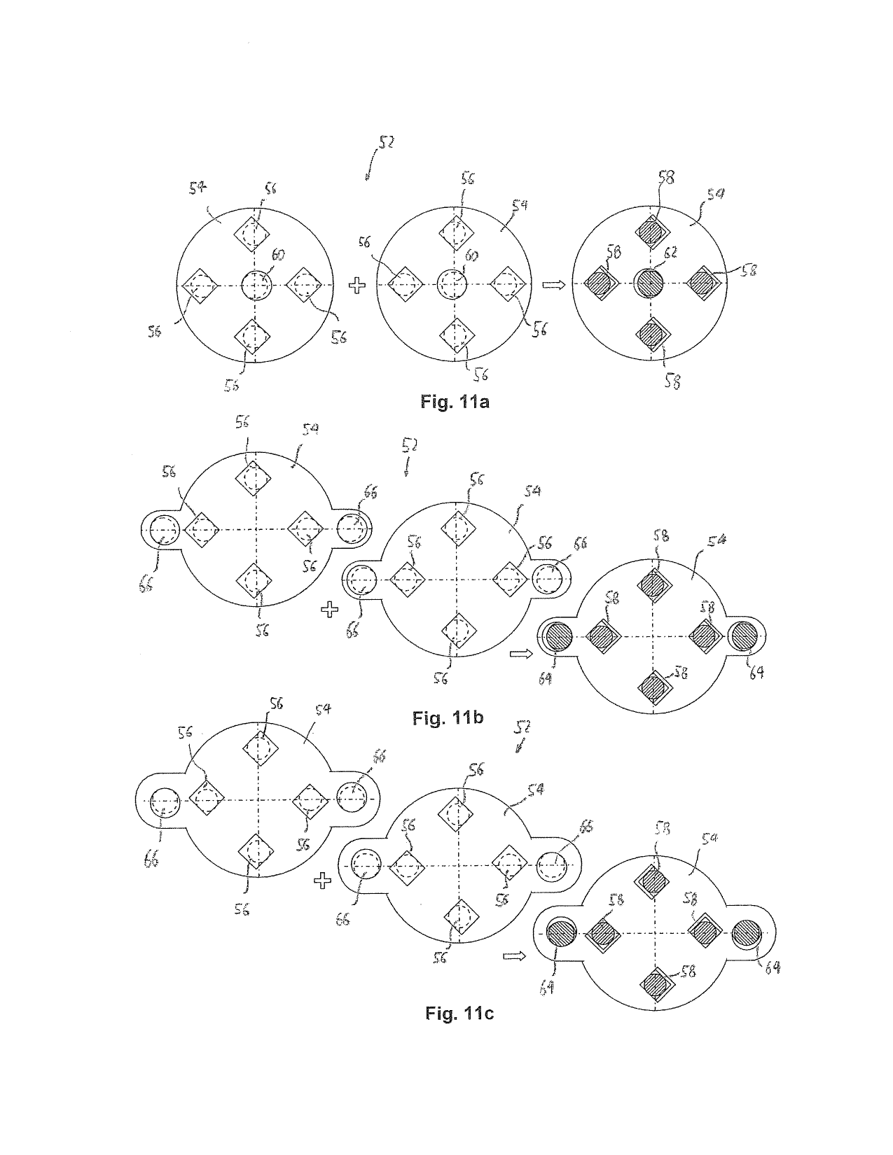

FIGS. 11a to 11c show similar systems 52 using the same lamellae 54 as the embodiments of FIGS. 10a to 10c, but where the four objects 58 to be held by the system 52 have a circular diameter instead of a square diameter. Nevertheless, the corresponding pockets 56 are still of square shape.

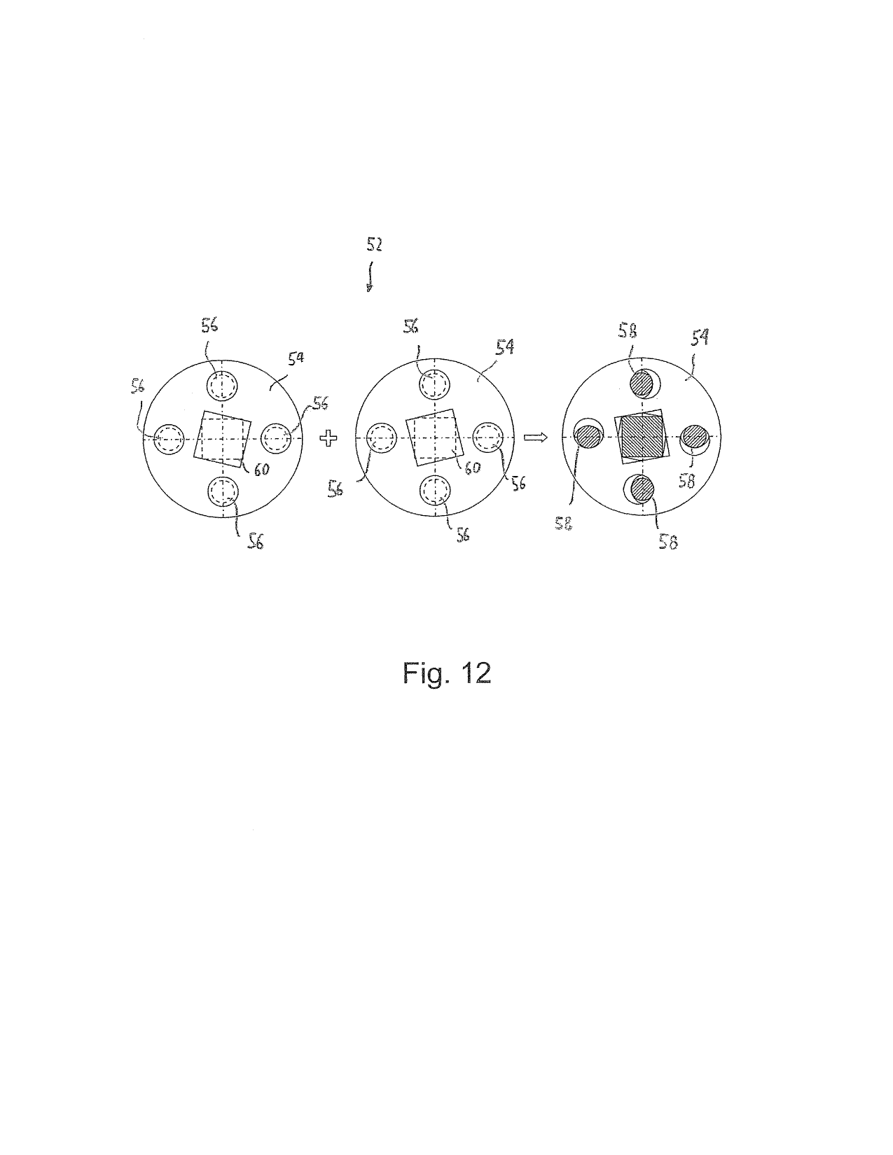

Yet a further embodiment 52 is shown in FIG. 12 showing two lamellae 54 with one central pocket 60 and four outer pockets 56. All lamellae 54 are identical in structure, but every other lamella 54 of the stack is flipped upside-down, as is seen in FIG. 12, where for simplicity again only two lamellae 54 are shown. In this embodiment, it is seen that the relative position between the central pocket 60 and each of the outer pockets 56 in the left lamella 54 is different from the corresponding relative position in the right lamella, whether “deviation in relative position” here amounts to a different rotational orientation of the central pocket 60. As is seen from FIG. 12, due to the different rotational orientations of the central pocket 60 in the consecutive lamella, rotational climbing forces are generated in the stack.

This example hence demonstrates that a “deviation in relative position” does not necessarily mean that the distance between the midpoints of respective pockets must vary, but that the variation can amount to a change of orientation of a subset of pockets. Note that this embodiment nevertheless falls under the terms of the invention as stated in the summary of the invention, because the “relative position” of any given outer pocket 56 -with respect to the central pocket 60—differs in the consecutive lamellae, where the difference in this case amounts to a translation on a virtual circle around the center of the central pocket 60.

Although preferred exemplary embodiments are shown and specified in detail in the drawings and the preceding specification, these should be viewed as purely exemplary and not as limiting the invention. It is noted in this regard that only the preferred exemplary embodiments are shown and described, and all variations and modifications should be protected that presently or in the future lie within the scope of protection of the invention as defined by the appended claims.

### REFERENCE LIST

10 permanent magnet rotor

12 rotor shaft

14 rotor packet

16 lamellae

18 permanent magnet

20 reception pocket

22 projection

23 quadrature axis

24 central aperture

26 circumferential bridge

28 depression

29a, 29d ligaments

30 central tunnel

32 system for positioning and fixing objects

34 permanent magnet

36 rotor shaft

38 lamellae

38a outer piece of split lamella

38b inner piece of split lamella 38

40a-40d pocket

42 symmetry axis

44 pocket

46 tapered portion

47 hook-like arm

48 outer edge portion of inner piece 38b

50 inner edge portion of outer piece 38a

52 system for positioning and fixing objects

54 lamella

56 pocket

58 object to be fixed

60 central pocket

62 central object

64 peripheral object

66 peripheral pocket

What is claimed is:

1. A system for positioning and fixing a number of objects relative to each other, the system comprising:
a stack of lamellae, each lamella having a number of pockets for receiving said objects,
wherein at least some of the pockets are dimensioned such as to loosely receive the corresponding object without applying a substantive clamping force to the object, and
wherein the relative positions of at least some of the pockets in one subset of lamellae as oriented in the stack deviate from the relative positions of the same pockets in another subset of the lamellae such that a clamping force is generated between the objects and the stack of lamellae when the objects are inserted in the corresponding pockets of all lamellae of the stack of lamellae.

2. The system of claim 1, wherein said objects comprise magnets or a rotor shaft of an electric motor.

3. The system of claim 1, wherein said deviation in the relative positions of at least some of the pockets of at least some of the lamellae is such that a clamping force exerted by one of the lamellae on one object has a component opposite to the clamping force exerted by the same lamella to another object.

4. The system of claim 1, wherein said deviation in relative position of two pockets in a first subset of lamellae as compared to the relative position thereof in a second subset of lamellae is an increase in distance between the two pockets, and wherein in said first subset of lamellae, a clamping force is exerted on the objects received in said two pockets by respective pocket edge portions facing each other, and in said second subset of lamellae, a clamping force is exerted on the same objects received in the two pockets by respective pocket edge portions facing away from each other.

5. The system of claim 1, wherein the relative positions of a first subset of pockets of all lamellae as oriented in the stack are identical, and only the relative positions of the remaining pockets with respect to at least some of the pockets of the first subset of pockets deviate from each other for different lamellae as oriented in the stack.

6. The system of claim 5, wherein the first subset of pockets comprises all but one pocket of the lamellae.

7. The system of claim 5, wherein said first subset of pockets are arranged in a rotationally, symmetrical or mirror-symmetrical pattern on the lamellae.

8. The system of claim 6, wherein said remaining pocket is offset from the rotational symmetry axis or mirror symmetry plane, respectively.

9. The system of claim 7, wherein all lamellae of the stack are of identical shape but arranged at different rotational positions or up-/down-configurations.

10. The system of claim 1, wherein the pockets are formed by through holes in the lamellae or by recesses at least partially encompassing the object in a way allowing for a clamping force between the object and the lamella to occur.

11. The system claim 1, wherein each lamella comprises an outer piece and an inner piece, and wherein at least one pocket is formed in the inner piece and at least one further pocket is defined by an outer edge portion of the inner piece and an opposing inner edge portion of the outer piece.

12. The system of claim 11, wherein the outer pieces in all of the lamellae are identical, and the relative positions of at least one of the edges of the inner piece and the at least one pocket in said inner piece of one subset of lamellae deviate from the corresponding relative positions in another subset of lamellae.

13. The system of claim 1, wherein at least a portion of at least one of the objects has a tapered shape.

14. A method of positioning and fixing a number of objects relative to each other comprising:
forming a stack of lamellae each lamella having a number of pockets for receiving said objects, wherein the relative positions of at least some of the pockets in one subset of lamellae as oriented in the stack deviate from the corresponding relative positions in another subset of the lamellae; and
simultaneously or consecutively inserting the objects through corresponding pockets of the stack of lamellae, thereby generating a clamping force between the objects and the stack of lamellae due to said deviations of the relative positions of the pockets between different lamellae receiving the same.

15. The method of claim 14, wherein the relative positions of a first subset of pockets of all lamellae are identical and the corresponding objects are inserted through said first subset of pockets first, and subsequently the remaining one or more objects are inserted through said remaining pockets.
